(19) United States
(12) Patent Application Publication
(10) Pub. No.: US 2006/0261592 A1
(43) Pub. Date: Nov. 23, 2006

(54) Scrapbook organizer

(76) Inventor: Kathryn Mary O'Keefe, St. Petersburg, FL (US)

Correspondence Address: Kathryn M. O'Keefe;N. Alexander Nolte, 477 173rd Ave. E., N. Redington Beach, FL, 33708, US

(21) Appl. No.: 11/135,193

(22) Filed: May 23, 2005

(51) Int. Cl. B42D 1/08

(52) U.S. Cl. 281/22

(57) ABSTRACT

Embodiments of the invention are generally related to a scrapbook having a media storage apparatus integrally positioned therein. The media storage apparatus is configured to contain media, such as film negatives, CD ROMs, memory sticks, etc. The media positioned in the storage apparatus generally contains the original images presented in the scrapbook, and as such, the storage apparatus serves to organize the scrapbook and images presented therein with the original image source, i.e., the image source for the images in the scrapbook are contained within the scrapbook itself. Embodiments of the invention are also related to a method for storing master digital media files representative of photos in a scrapbook integrally within a scrapbook itself.

### BACKGROUND OF THE INVENTION

1. Field of the Invention

Embodiments of the invention are generally related to a scrapbook having a media storage apparatus integrally positioned therein.

2. Description of the Related Art

Collection and retention of memorabilia items, such as photos, for example, has long been a favorite hobby of many individuals. Photo albums have been traditionally used for retaining photographs on photo album pages by positioning photographs in specially provided pockets, retaining photographs between a firm page and a transparent cover, or by engaging comers of the photographs in mounted brackets or slots attached to the photo album page.

In recent years however, collectors and hobbyists have been using a more advanced form of a photo album generally referred to as “scrapbook.” Scrapbooks are similar to photo albums in configuration and are generally used to retain objects that have monetary or purely sentimental value. Some of the items retained in the scrapbook pages may be photos, concert tickets, personal letters, autographs, wedding invitations, graduation announcements, dried flowers, etc. Scrapbooks are in many ways different from the traditional photo albums in that they are generally much more elaborate that traditional photo albums.

Scrapbooks are available from a variety of sources in different designs, varying in shapes, sizes, number of pages in the scrapbook, etc. Generally scrapbooks have front and back covers of sturdy construction joined by a spine with a plurality of pages retained between the covers. The pages themselves are designed for retaining the display media in the scrapbook.

The pages that are incorporated into the scrapbooks are usually blank (aside from any decorative design on the pages), thus allowing the user to insert and display items in any desired order on the page. The individual may incorporate writings, drawings, and other personalized touches to the pages of the scrapbook to accompany the memorabilia items and make the story “come to life” for the person glancing through the scrapbook. Art supply and stationary stores also sell a variety of preprinted designs that can be glued or otherwise attached to the page together with a photograph, invitation, postcard, etc. to further personalize the scrapbook page.

Many scrapbooks today are used primarily to display photographs. However, one challenge associated with photo scrapbooks is that conventionally, scrapbook users will obtain photograph prints from a mater film media, and then insert the prints into the scrapbook. The original master film media that the photographs are stored on, e.g., the film negatives, CD ROM, computer hard drive, memory stick, etc. are conventionally stored in a separate place from the scrapbook. This presents a challenge when, for example, a family member is viewing a photo scrapbook and sees a photo that they would like to have a copy of. With conventional scrapbooks, when a person wants a copy of a photo in the scrapbook, the scrapbook owner must then go to the storage location for the photo master media. In a best case scenario, for example, this may be a photo master media storage bin that the scrapbook owner has created that contains all of the master media for their scrapbooks. The scrapbook owner must sort through the master media to find the appropriate master media that matches the particular desired photo from the scrapbook. Is a less desirable situation, for example, the scrapbook owner does not even have an master media organization bin. In this situation, the owner must search for the particular master media that contains the desired photo.

Therefore, the inventor has determined that there is a need for an organization apparatus for master media for photo scrapbooks. More particularly, there is a need for an apparatus for storing photo master media within integrally with a scrapbook, wherein the master media stored integrally within the scrapbook contains the masters for the media displayed in the scrapbook.

### SUMMARY OF THE INVENTION

Embodiments of the invention generally provide a scrapbook having a master media storage apparatus integrally positioned therein. The media storage apparatus is configured to contain media, such as film negatives, CD ROMs, memory sticks, etc. The media positioned in the storage apparatus generally contains the original images presented in the scrapbook, and as such, the storage apparatus serves to organize the scrapbook and images presented therein with the original image source, i.e., the image source for the images in the scrapbook are contained within the scrapbook itself.

Embodiments of the invention may further provide a method for organizing photos in a scrapbook integrally with a photo storage media that contains master copies of the photos displayed in the scrapbook. The method generally includes positioning photos in a scrapbook, and then storing master images of the photos displayed in the scrapbook integrally in the scrapbook via a storage receptacle configured to hold the master images, wherein the storage receptacle is positioned within the scrapbook itself.

Embodiments of the invention may further provide a photo scrapbook that contains a non-volatile digital memory device within the scrapbook itself. The digital memory device may be positioned anyplace within the scrapbook itself and may include any type of digital memory device configured to store a plurality of digital image files. This embodiment of the invention also includes a bi-directional interface that connects to the digital memory device. The interface is configured to connect to external devices and to receive/send images therefrom/thereto.

Embodiments of the invention may further provide a method for storing master image files representative of photos displayed in a photo scrapbook integrally with the scrapbook itself. The method of this embodiment of the invention generally includes providing a digital storage device integral to a scrapbook, and providing a bi-directional interface connected to the digital memory device that is configured to communicate with external devices. The exemplary method of the invention further provides that the user of the scrapbook of the invention may connect a computer or digital camera to the memory of the scrapbook and download image files representative of the photos displayed in the scrapbook onto the memory device in the scrapbook. This allows for the master digital images of the photos displayed in the scrapbook to be stored in the digital memory device integral with the scrapbook.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a perspective view of an exemplary scrapbook of the invention.

FIG. 2 illustrates a perspective view of an exemplary media storage device of the invention.

FIG. 3 illustrates a sectional view of an exemplary media storage device of the invention.

FIG. 4 illustrates a perspective view of an exemplary scrapbook page of the invention.

### DETAILED DESCRIPTION OF THE PREFERRED EMBODIMENT

The present invention generally provides an apparatus and method for organizing a photo scrapbook integrally with the original master media for the photos contained in the scrapbook. The scrapbook of the invention utilizes a master media storage device integrated into a scrapbook, wherein the master media storage device is configured to contain master media, such as film negatives, CD ROMs, memory sticks, and other media configured to contain photo images thereon. The master media contained in the media storage device generally contains the original master images that are displayed in the photo scrapbook, and as such, when a user of the scrapbook desires to access the master media for any photo displayed in the scrapbook, the user only needs to open the media storage device contained in the scrapbook. The incorporation of the integral master media storage device into the scrapbook of the invention optimally organizes the master media for the scrapbook and allows for quick and easy access to the master media so that viewers of the scrapbook may, for example, print a copy of a photo displayed in the scrapbook without having to search through an external storage bin to find the master media that contains the desired photo to be printed.

FIG. 1 illustrates a perspective view of an exemplary scrapbook of the invention that incorporates a master media storage apparatus into the scrapbook. The exemplary scrapbook 100 of the invention illustrated in FIG. 1 may contain a front cover 102, a back cover 104, and a binding device 103 configured to pivotally or hingedly connect the front cover 102 to the back cover 103. The front and back covers 102, 104 are generally manufactured from a somewhat rigid material configured to operate as a structural support for the scrapbook 100. A plurality of scrapbook pages 106 are generally positioned interstitially with respect to the front 102 and back 104 covers. The scrapbook pages 106 may be secured to the binding portion 103 by a securing device 108, which, for example, may be a ringed binder configuration, a spiral binder configuration, a glued binder configuration, or any other binding configuration generally used in the book or notebook industries. The binding 103 and the securing device 108 generally operate to pivotally secure the plurality of scrapbook pages 106 so that the pages 106 may be flipped or turned to view a front and back surfaces of each page 106.

The exemplary scrapbook 100 of the invention further includes a master media storage device 110 integrally positioned in the scrapbook 100. In the present invention, the term “integrally”, when discussing the storage device, is intended to mean within the scrapbook itself, e.g., the storage device is positioned in the scrapbook itself and moves contiguously therewith. The master media storage device 110 may be positioned on or within any of the front cover 102, the back cover 104, the binding 103, or any of the individual scrapbook pages 106. The inventor intends that the phrase “positioned on” mean that the media storage device 110 may be attached to an external surface of the respective cover or binding indicated. Further the inventor intends that the phrase “positioned within” mean the media storage device may be positioned in an inner portion of the respective cover or binding. For example, the inventors contemplate that in one embodiment of the invention the media storage device 110 may be positioned inside one of the pages 106 such that the outer surfaces of the respective pages are still useable for photo display, i.e., the media storage device may be concealed or contained between the outer surfaces of the page 106. In another embodiment of the invention, the media storage device 110 may be positioned in an interior portion of the front or back cover 102, 104 such that the media storage device is not visible to a viewer of the scrapbook.

In another embodiment of the invention the media storage device 110 may be positioned on one of the pages 106 or covers 102, 104, and then the media storage device 110 may have a cover 112 positioned to conceal the media storage device 110 from plain view. The cover 112, as illustrated in FIG. 1, may be hingedly or pivotally attached to the respective page 106 or cover 102, 104. For example, cover 112 may be attached to the respective page 106 or cover 102, 104 such that the cover 112 may pivot about an axis “A” in the direction indicated by arrow “B”. This pivotal movement allows cover 112 to be opened and closed to allow access to a media storage device 110 positioned behind the cover 112. The cover 112 may have a decorative design on the outer surface thereof, such that the cover 112 may contiguously blend with the aesthetics of the remainder of the scrapbook pages, and as such, hide the media storage device 110 from plain view.

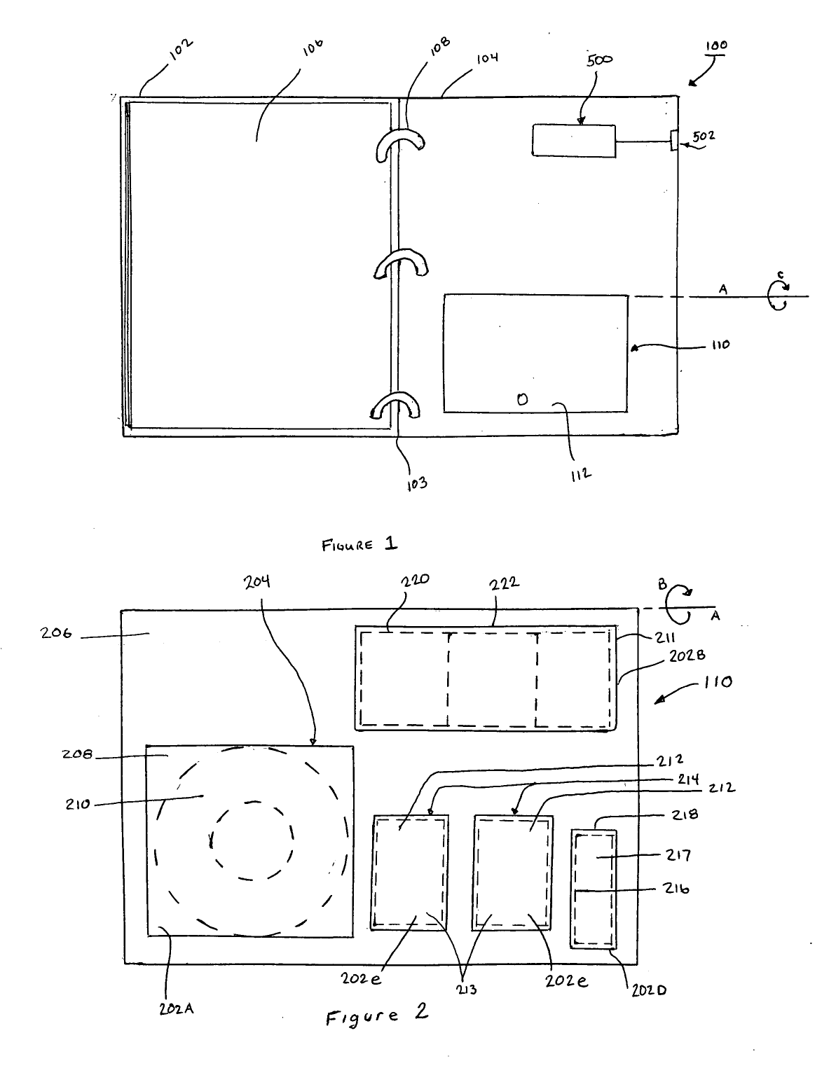

FIG. 2 illustrates a more detailed perspective view of an exemplary media storage device 110 of the exemplary embodiments of the invention illustrated in FIG. 1. The media storage device 110 generally includes a base or backing 206 that is substantially planar. The base or backing 206 may be of similar construction to the scrapbook pages 106, the base or backing 206 may be as rigid as poster board, or the base or backing may be as thin and flexible as plastic sheeting, for example. The base or backing may also be an existing structure of the scrapbook 100, such as the inner surface of the front cover 102, the inner surface of the back cover 104, or one of the surfaces of the scrapbook pages 106. The media storage device 110 includes at least one and possibly a plurality of media storage receptacles 202A, 202B, 202C, and 202D (collectively referred to herein as “receptacles 202” where applicable) positioned thereon. Each of the receptacles 202 may be sized and configured to receive and contain a particular type of photo containing media.

For example, receptacle 202A may be sized and configured to contain a computer readable CD ROM (shown in phantom lines as 210) that contains digital or scanned photos. Similarly, receptacle 202B may be sized and configured to contain conventional photographic negative film strips (shown in phantom lines as 220). Further, receptacle(s) 202C may be sized and configured to contain a digital film canister (shown in phantom lines as 212), such as the film canisters that are removed from cameras for film developing but are configured to subsequently contain the film negatives themselves after developing for storage, such as those manufactured and sold by Kodak®. Further still, receptacle 202D may be sized and configured to contain a digital memory device or stick (shown in phantom lines as 216) containing digital images thereon.

Each of receptacles 202 generally include a back (which may generally be the base or backing 106 of the scrapbook 100) and a front containing member. For example, CD ROM receptacle 202A may have a front containing member 208 that comprises a substantially planar member sized, positioned, and configured to form a slot or sleeve between the backing 106 and the front containing member 208. The slot or sleeve formed by the backing 106 and the front containing member 208 may be sized to receive and secure a photo containing CD ROM 210 (shown in phantom lines) therein. As such, the spacing between the backing 106 and the front containing member 208 may be between about 1 mm and about 4 mm and the width of the slot formed by the back 106 and the front containing member 208 may be sized to receive a CD ROM. This spacing may be adjusted to a larger spacing parameter if multiple CD ROMs are to be held within receptacle 202A or if alternative sized CD ROMs are used. The edges of the front containing member 208 may be attached to the backing 106 on three sides, this forming an insertion slot 204 that may be used to insert the photo containing CD ROMs into the receptacle 210 for storage.

Film negative containing receptacle 202B may be configured similarly to CD ROM receptacle 202A. More particularly, receptacle 202B may include a backing 106 and a substantially planar front containing member 211. Containing member 211 may be constructed similarly to front containing member 208, in that containing member 208 may be sized and configured to generate a gap or space between the backing 106 and the containing member 211. The gap or space may be sized and configured to receive, for example, conventional film photo negatives (shown in phantom lines as 220). As such, the space formed between the backing 106 and the front containing member may be between 1 mm and about 5 mm deep and may have a width and height sufficient to receive photo negatives 220 therein. This spacing may be adjusted to a larger spacing parameter if multiple film negatives or negative packs are to be held within receptacle 202B. The edges of the front containing member 211 may be attached to the backing 106 on three sides (generally the bottom, left, and right sides), thus forming an insertion slot 222 that may be used to insert the photo negatives 220 into the receptacle 202B from the top for storage.

Digital film canister containing receptacle(s) 202C may be configured similarly to receptacles 202A and 202B. More particularly, receptacle 202C may include a backing 106 and a front containing member 213. Containing member 213 may be constructed similarly to front containing members 208 and 211, in that containing member 213 may be sized and configured to generate a gap or space between the backing 106 and the containing member 213. The gap or space may be sized and configured to receive, for example, digital film canisters (shown in phantom lines as 212). As such, the space formed between the backing 106 and the front containing member 213 may be between 15 mm and about 25 mm deep and may have a width and height sufficient to receive digital film canisters 212 therein. This spacing may be adjusted to a larger spacing parameter if multiple film canisters 212 are to be held within receptacle 202C. The edges of the front containing member 213 may be attached to the backing 106 on three sides (generally the bottom, left, and right sides), thus forming an insertion slot 214 that may be used to insert the film canisters 213 into the receptacle 202C from the top for storage.

Digital memory device receptacle 202D may be configured similarly to receptacles 202A, 202B, and 202C. Digital memory device receptacle 202D may include a backing 106 and a front containing member 217. Containing member 217 may be constructed similarly to front containing members 208, 211, and 213 in that containing member 217 may be sized and configured to generate a gap or space between the backing 106 and the containing member 217. The gap or space may be sized and configured to receive, for example, digital memory devices (shown in phantom lines as 216), such as digital camera memory cards memory sticks, or other digital memory devices. As such, the space formed between the backing 106 and the front containing member 213 may be between lmm and about 25 mm deep and may have a width and height sufficient to receive digital memory devices 216 therein. This spacing may be adjusted to a larger spacing parameter if multiple memory devices 216 are to be held within receptacle 202D. The edges of the front containing member 217 may be attached to the backing 106 on three sides (generally the bottom, left, and right sides), thus forming an insertion slot 218 that may be used to insert the memory devices 217 into the receptacle 202D from the top for storage.

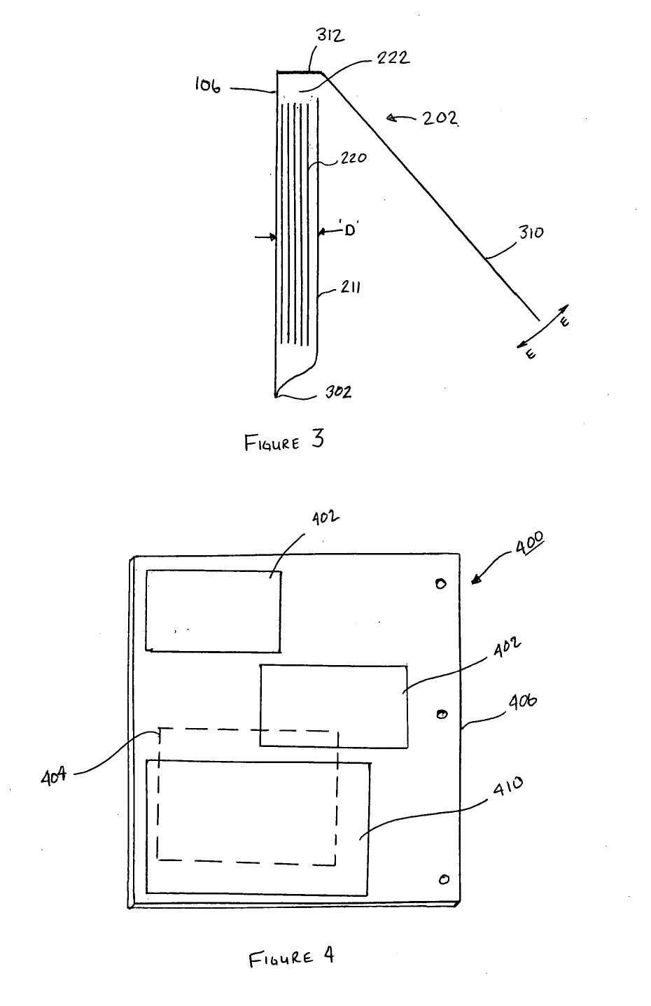

FIG. 3 illustrates a sectional view of an exemplary media storage device of the invention. The exemplary storage device illustrated in FIG. 3 may be the film negative receptacle 202B illustrated in FIG. 2, for example. Receptacle 202B is generally formed by the backing member 106 and the front containing member 211. The front containing member 211 is attached to the backing member 106 along a bottom portion thereof along a line that goes into the page, which is illustrated as 302 in FIG. 3. The vertical terminating edges of the front containing member 211 (located on the terminating longitudinal ends thereof) are also attached to the backing member 106. The combination of the attachment of the vertical terminating ends and the bottom edge of the front containing member 211 to the backing member 106 forms the receptacle 202 having an open fourth side 222 that may receive contents for the receptacle 202. The depth of the receptacle 202, which is generally illustrated as dimension “D” in FIG. 3, may be increased or decreased to accommodate various sizes of photo containing media. For smaller or thinner photo containing media, such as film negatives, for example, the depth D may be between 1 mm and about 5 mm. For larger photo containing media, such as digital film canisters, for example, the depth may be between about 10 mm and about 30 mm. The length of each of the containers 202 may be sized to receive various photo containing media, and as such the length, for example, may be between about 10 mm and about 250 mm. Similarly, the height of each of the containers 202 may be sized to receive various photo containing media, and as such the height, for example, may be between about 10 mm and about 250 mm.

In another embodiment of the invention, the media containing receptacle 202 may be detachable from the scrapbook. For example, the receptacle 202 may be a stand alone device configured to receive photo containing media, which may also be detachably or permanently secured to a surface of a scrapbook. For example, receptacle 202A may comprise a plastic, paper, or cardboard sleeve (other materials suitable for receiving and storing a CD ROM may also be used) having a front and back surfaces that form a CD ROM receiving slot there between. The CD ROM receiving sleeve may be selectively attached to a surface of the scrapbook (selected by the user) via a peel off adhesive strip, Velcro®, tape, user applied adhesive, or other means of affixation suitable for the scrap booking industry. Similar sleeves or selectively attachable receptacles, such as those configured to contain film negatives of film negative cartridges, may be used to accommodate various photo containing media other than CD ROMS, and the inventors contemplate implementation of these devices into embodiments of the present invention.

In another embodiment of the invention, each of the photo media containing receptacles may have selectively operable cover, as generally illustrated in FIG. 1 as 112. Returning to the embodiment of the invention illustrated in FIG. 3, the receptacle 202 may include a cover 310. The cover 310 may pivot about a point 312 in the direction indicated by arrows “E” to open and close. When the cover 310 is in an open position the user has access to the photo containing media. When the cover 310 is in a closed position the photo containing media is out of sight. Further, the outer surface of the cover 310 may have a decorative design thereon. The design may match the theme of the scrapbook so that the receptacle 202 may contain photo media without being visible to viewers of the scrapbook. In a further embodiment of the invention, the outer surface of the cover 310 may include another receptacle configured to receive a photo therein. As such, the cover 310 of the receptacle 202 may have a photo attached thereto so that the user may view the scrapbook without knowing that the photo containing media is contained integrally in the scrapbook.

In another embodiment of the invention, the photo media containing receptacle may include a slot formed into one of the pages of the scrapbook. More particularly, in this embodiment of the invention illustrated in FIG. 4, one or more of the conventional scrapbook pages 400 configured to display photos 410 may be modified to include a photo media containing receptacle 404 (shown in phantom lines). The receptacle 404 may be positioned in an interior portion of a scrapbook page 400. For example, the scrapbook page 400 may consist of two backing members 406 secured together in a manner that forms a receptacle between the respective backing members 406. For example, three perimeter edges of the backing members 406 may be secured together to form a two sided scrapbook page 400 configured to display photos 410. The fourth side of the scrapbook page 400 that does not have the backing members 406 secured together may allow for insertion of the photo containing media into the space (receptacle 404) between the backing members 406. Thus, in this embodiment of the invention, the photo containing media may be stored integrally with a scrapbook page 400, and the scrapbook page 400 of the invention may be incorporated into any conventional scrapbook. The open side of the page may be selectively secured in a closed position to prevent the photo containing media from falling out of the inner portion of the page. The open side may be selectively secured in the closed position by, for example, a Velcro® strip positioned between the inner surfaces of the backing members 106 on the open side of the page.

Another embodiment of the invention provides a method for organizing photos in a scrapbook integrally with a photo storage media that contains master copies of the photos displayed in the scrapbook. The exemplary method of the invention generally includes positioning photos in a scrapbook, storing master images (photo negatives, digital photo files, etc.) of the photos displayed in the scrapbook on a photo storage medium, and then storing the photo storage medium integrally within the scrapbook. The photo storage medium may be received and stored in a receptacle positioned within the scrapbook itself. The master images may be stored on film negatives, CD ROMs, digital storage media, or other means known to store master photo images. The method of the invention

In another embodiment of the invention a photo scrapbook may contain a digital storage medium integral to the structure of the scrapbook. The exemplary scrapbook of this embodiment of the invention generally includes a digital memory device 500 (see, FIG. 1), such as a memory stick or memory chip, positioned in the scrapbook. The digital memory 500 may also include an interface 502 that is configured to connect to external devices, such as personal computers, cell phones, digital cameras, and other electronic devices capable of taking or storing digital images. The interface 502 may include a plug positioned on an exterior portion of the scrapbook, such that the interface 502 may be accessed from an exterior of the scrapbook, i.e., a wire or matching plug connected to an external device may be plugged into the plug on the scrapbook for electronic communication with the digital memory 500 integrally positioned in the scrapbook. The digital memory 500 may any form of non-volatile memory suitable for storing a plurality of digital image files over long periods of time, e.g., generally at least 10 years without degradation. In this embodiment of the invention, the user of the scrapbook 100 may use an interface cable (not shown) to connect a PC or digital camera directly to the memory 500 in the scrapbook 100 via the interface 502. The digital master images of photos displayed in the photo scrapbook 100 may then be transmitted to the memory 500 in the scrapbook 100. This allows for the master images of the photos stored in the scrapbook to be stored integrally with the scrapbook.

Another embodiment of the invention includes a method for storing master digital images for photos in a scrapbook within a memory integral to the scrapbook itself. The exemplary method of the invention generally includes providing a digital storage device integral to a scrapbook. The digital storage device, which may, for example, be a memory stick, RAM, SDRAM, or other non-volatile memory device suitable for storing multiple image files, may be positioned in a front cover, a back cover, in a binding, or in another suitable part of the scrapbook. This embodiment of the invention also includes an interface connected to the digital memory device. The interface is generally configured to allow for electronic connection between the digital memory device within the scrapbook and an external electronic device, such as a computer, digital camera, or another device suitable for taking and/or storing digital images. The interface generally includes a bi-directional setup, such that images may be loaded onto the digital memory, as well as copied from the digital memory. Once the digital memory and interface are provided, the user of the scrapbook of the invention may connect a computer or digital camera to the memory of the scrapbook and download image files representative of the photos displayed in the scrapbook onto the memory device. This allows for the master digital images of the photos displayed in the scrapbook to be stored in the digital memory device integral with the scrapbook.

In another embodiment of the invention the inventors contemplate that any combination of the embodiments or features of the invention described above may be used to generate another embodiment of the invention. The inventors contemplate that any of the features and embodiments of the invention described above are novel and unobvious, and as such, various combinations of these features and elements may be used to generate additional embodiments of the invention. Further, the description of the invention above, reference is made to embodiments of the invention. However, it should be understood that the invention is not limited to the specifically described embodiments. Rather, the inventors contemplate that any combination of the above noted features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the above described aspects, features, embodiments, and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

1. A photograph containing scrapbook, comprising:
a front and back covers;
a page binding device connecting the front and back covers;
at least one scrapbook page connected to the binding device, each of the at least one scrapbook pages being configured to receive and display at least one photograph; and
a receptacle configured to contain a photograph master media device, wherein the master media device contains master images of the photographs displayed on the scrapbook pages.

2. The photograph containing scrapbook of claim 1, wherein the receptacle comprises a sleeve configured to contain at least one of a CD ROM and photograph negatives.

3. The photograph containing scrapbook of claim 2, wherein the sleeve further comprises a pivotally mounted cover positioned to cover the sleeve from view in a closed position and to allow access to the sleeve in an open position.

4. The photograph containing scrapbook of claim of claim 3, wherein the cover comprises a decorative outer surface that matches a decorative theme of the scrapbook.

5. The photograph containing scrapbook of claim 1, wherein the receptacle is positioned on at least one of the front cover, the back cover, or a scrapbook page.

6. The photograph containing scrapbook of claim 1, wherein the receptacle is positioned in an interior volume of a scrapbook page.

7. The photograph containing scrapbook of claim 6, wherein the scrapbook page comprises:
a first backing member; and
a second backing member attached to the first backing member on three of four perimeter edges to define the interior volume between the first and second backing members, the interior volume being externally accessible via a slot formed by the unattached fourth edges.

9. The photograph containing scrapbook of claim 1, wherein the receptacle comprises at least one of a selectively attachable CD ROM sleeve and a selectively detachable photograph negative sleeve.

10. A photograph containing scrapbook, comprising:
a front and back covers connected by a binding device;
a plurality of photograph displaying pages attached to the binding device;
a digital memory storage device positioned integrally in the scrapbook; and
an electronic interface positioned in the scrapbook and being in electronic communication with the digital memory storage device, the interface being configured to facilitate bi-directional communication between the digital memory storage device and an external electronic device.

11. The photograph containing scrapbook of claim 10, wherein the digital memory storage device comprises at least one of a digital memory stick, a RAM device, a SDRAM device, and a DRAM device.

12. The photograph containing scrapbook of claim 10, wherein the electronic interface comprises a plug positioned for access from an exterior of the scrapbook.

13. The photograph containing scrapbook of claim 10, wherein the digital memory storage device comprises a non-volatile memory device.

14. The photograph containing scrapbook of claim 10, wherein the digital memory storage device is configured to store a plurality of master digital images representative of photographs displayed in the scrapbook.

15. A method for organizing master photograph media for photograph displaying scrapbook, comprising:
displaying a plurality of photographs in the scrapbook; and
storing master media representative of the photographs in the scrapbook integrally within the scrapbook.

16. The method of claim 15, wherein storing further comprises:
storing the master media onto a CD ROM; and
placing the CD ROM into a CD ROM receiving sleeve that is attached to the scrapbook.

17. The method of claim 15, wherein storing further comprises:
storing the master media onto film negatives; and
placing the film negatives into film negative receiving sleeve that is attached to the scrapbook.

18. The method of claim 15, wherein storing further comprises transmitting the master media representative of the photographs in the scrapbook through an electronic interface to an electronic memory device integrally positioned in the scrapbook.

19. The method of claim 18, wherein the electronic interface comprises a bi-directional electronic communication interface.

20. The method of claim 19, further comprising selectively retrieving the master media from the electronic memory device via the interface.
